(19) United States
(12) Patent Application Publication
(10) Pub. No.: US 2012/0265533 A1
(43) Pub. Date: Oct. 18, 2012

(54) VOICE ASSIGNMENT FOR TEXT-TO-SPEECH OUTPUT

(75) Inventor: Jonathan David Honeycutt, Sunnyvale, CA (US)

(73) Assignee: APPLE INC., Cupertino, CA (US)

(21) Appl. No.: 13/088,661

(22) Filed: Apr. 18, 2011

(51) Int. Cl. G10L 13/08

(52) U.S. Cl. 704/260; 704/E13.001

(57) ABSTRACT

Text can be obtained at a device from various forms of communication such as e-mails or text messages. Metadata can be obtained directly from the communication or from a secondary source identified by the directly obtained metadata. The metadata can be used to create a speaker profile. The speaker profile can be used to select voice data. The selected voice data can be used by a text-to-speech (TTS) engine to produce speech output having voice characteristics that best match the speaker profile.

### TECHNICAL FIELD

This disclosure relates generally to text-to-speech systems and methods.

### BACKGROUND

Many modern computing devices (e.g., personal computers, smart phones, electronic tablets, television systems) run applications that convert text to speech. This conversion allows a user to listen to messages received in text format through email, texting or other communication technology. Such applications are especially useful to vision impaired users. Text-to-speech engines often generate synthesized speech having voice characteristics of either a male speaker or a female speaker. Regardless of the gender of the speaker, the same voice is used for all text-to-speech conversion regardless of the source of the text being converted.

### SUMMARY

Text can be obtained at a device from various forms of communication such as e-mails or text messages. Metadata can be obtained directly from the communication or from a secondary source identified by the directly obtained metadata. The metadata can be used to create a speaker profile. The speaker profile can be used to select voice data. The selected voice data can be used by a text-to-speech (TTS) engine to produce speech output having voice characteristics that best match the speaker profile.

Particular implementations of voice assignment for synthesized speech, provides one or more of the following advantages. Text can be converted to speech using a voice that best matches a speaker profile that includes gender, age, dialect or any other metadata that defines voice characteristics of the speaker. Providing a speech output that is associated with a speaker profile allows speaker recognition while providing a more enjoyable and entertaining experience for the listener.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1A illustrates a user interface of an email application including primary metadata for generating a speaker profile.

FIG. 1B illustrates an electronic contact card including secondary metadata for generating a speaker profile.

FIG. 2 is a block diagram of TTS system for outputting speech having voice characteristics based on a speaker profile.

FIG. 3A illustrates the parsing of metadata to generate a speaker profile.

FIG. 3B illustrates a voice database.

FIG. 4 is a flow diagram of an exemplary process for voice assignment to speech output based on speaker profiles.

FIG. 5 is a block diagram of an exemplary device architecture that implements the features and processes described with reference to FIGS. 1-4.

Like reference symbols in the various drawings indicate like elements.

### DETAILED DESCRIPTION

### Exemplary Communications & Metadata

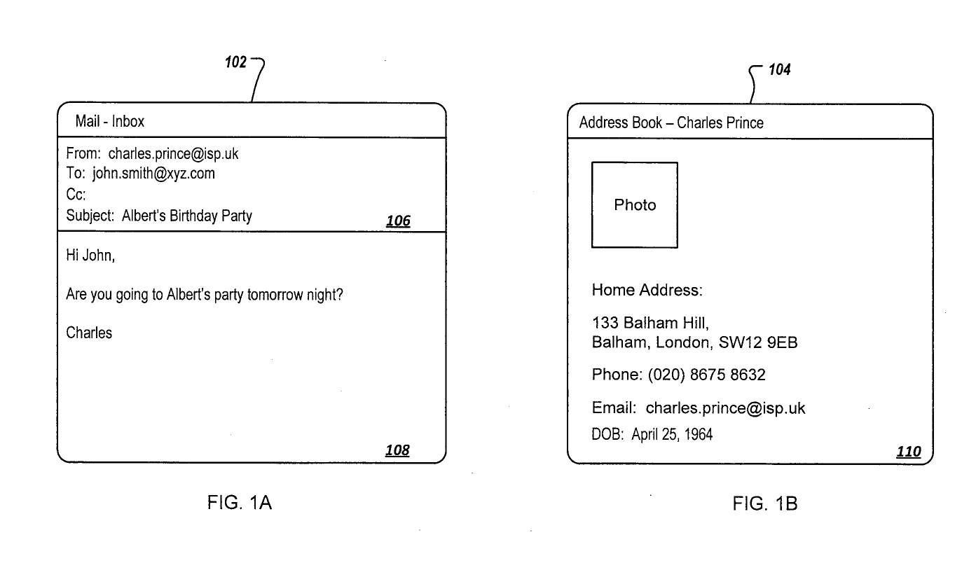

FIG. 1A illustrates a user interface 102 of an e-mail application including primary metadata for creating a speaker profile. The e-mail application can be running on any device capable of receiving e-mail communications (e.g., a computer, smart phone, e-mail device, electronic tablet). In this example, an e-mail header 106 indicates that the author of the e-mail is Charles Prince having the e-mail address, charles.prince@isp.uk, and the recipient is John Smith having an e-mail address, john.smith@xyz.com. The e-mail includes a text message 108 regarding a birthday party for Albert. The e-mail address is referred to as primary metadata.

FIG. 1B illustrates an electronic contact card 104 including secondary metadata for creating a speaker profile. In the example shown, contact card 104 is for Charles Prince and can be stored in John Smith's electronic address book. The address book can be part of an address book application running on a device (e.g., computer, smart phone) that allows John to manage a database of contacts. In some implementations, the address book can also be stored on a network. In the example shown, the contact card 104 includes secondary metadata 110 associated with John, including a photo of Charles and contact information. In this example, Charles's contact information includes a home address, phone number, e-mail address and date of birth (DOB).

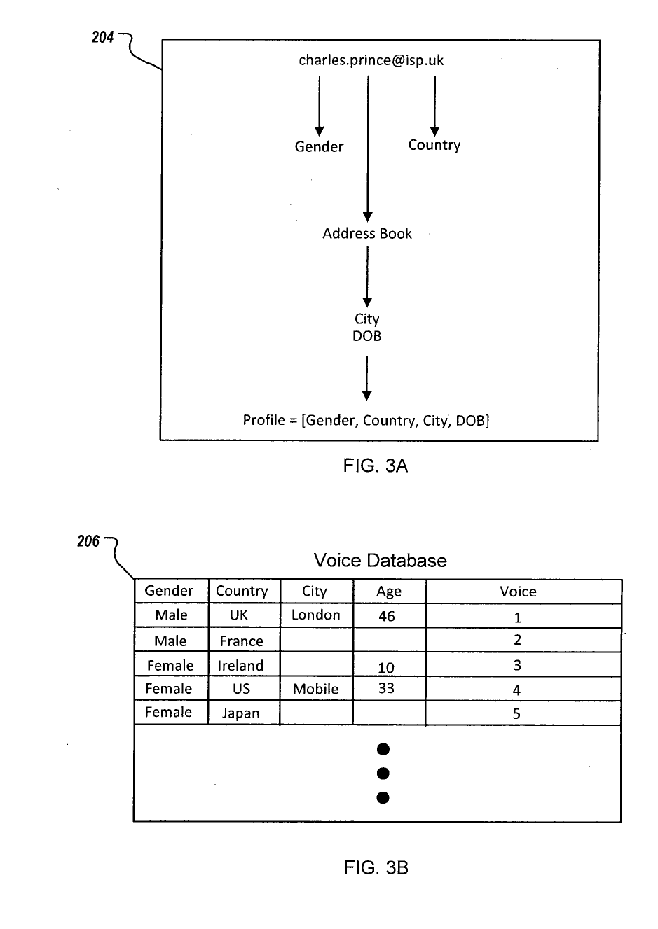

Contact card 104 can be part of the communication. For example, it can be included as an attachment to an e-mail or text message. Contact card 104 can also be identified by primary metadata in the communication. In the former example, contact card 104 is primary metadata, and in the latter example, contact card 104 is secondary metadata. Secondary metadata is not part of a communication, but is identified by primary metadata included in the communication. In the example shown, the last name “Prince” was used to identify contact card 104 in John Smith's address book, as described in reference to FIG. 3A.

As will be described in reference to FIGS. 3A and 3B, the e-mail from Charles includes various primary metadata that can be used to create a speaker profile. Generally, the term “speaker” as used herein refers to the author of a communication that includes text that is to be converted into speech. In this example, Charles is the speaker and the metadata about Charles is used to create a speaker profile for Charles. Other communications can include but are not limited to text messages, recorded telephone calls, blogs, tweets and any other communication technology that can include text. A communication can also be an electronic publication, such as an e-book or e-newspaper. A communication can also be a user interface of a webpage, application or operating system, which contains text that can be converted to speech.

### Exemplary TTS System

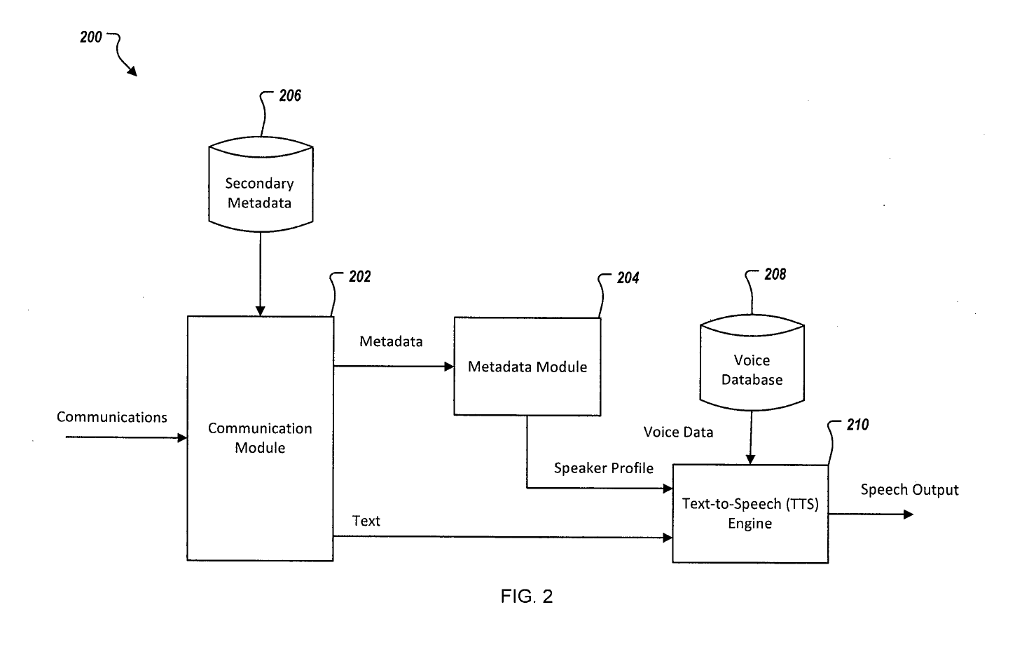

FIG. 2 is a block diagram of TTS system 200 for outputting speech having voice characteristics based on a speaker profile. In some implementations, system 200 can include communication module 202, metadata module 204, secondary metadata 206, voice database 208 and TTS engine 210.

Communication module 202 receives communications (e.g., e-mail, text message) and identifies metadata. Metadata (e.g., e-mail address, contact card information) is used by metadata module 204 to generate a speaker profile. A speaker profile includes information that can be used to determine a voice characteristic, including but not limited to gender, age and dialect. The information can be derived from primary metadata contained in the communication (e.g., e-mail address) or can be accessed from secondary metadata 206. The raw text and the speaker profile is input to TTS engine 210. TTS 210 uses the speaker profile to select voice data from voice database 208. The voice data is used by TTS engine 210 to convert the raw text to speech having voice characteristics that best match the speaker profile.

In some implementations, the speech can be created by concatenating pieces of recorded speech that are stored in voice database 208. Voice database 208 can store phones, diphones or entire words or sentences. The recorded speech can be organized or indexed in voice database 208 based on information contained in a speaker profile, such as gender, age and dialect. In some implementations, the speaker profile can be formed into a query of search terms that can be used to search voice database 208 for recorded speech that best matches the query.

In some implementations, TTS engine 210 includes a synthesizer that incorporates a model of the human vocal tract or other human voice characteristics to create a synthetic speech output according to the speaker profile. TTS engine 210 converts the raw text containing symbols like numbers and abbreviations into the equivalent of written words. TTS engine 210 performs text-to-phoneme or grapheme-to-phoneme conversion where phonetic transcriptions are assigned to each word and the text is divided and marked into prosodic units, like phrases, clauses and sentences. Phonetic transcriptions and prosody information together make up a symbolic linguistic representation of the raw text. The synthesizer converts the symbolic linguistic representation into sound. The synthesizer can include the computation of a target prosody (e.g., pitch contour, phoneme durations), which is applied to the output speech. The target prosody can be determined based on the voice data that is selected based on a speaker profile.

In some implementations, a speaker's voice can be recorded and analyzed to generate voice data. For example, the speaker's voice can be recorded by a recording application running on the device or during a telephone call (with permission). The voice characteristics of the speaker can be obtained using known voice recognition techniques. In this implementation, a speaker profile may not be necessary as the speaker's name can be directly associated with voice data stored in voice database 208.

### Exemplary Metadata Module

FIG. 3A illustrates the parsing of metadata to generate a speaker profile. Continuing with the example of FIGS. 1A-1B, the primary metadata source is the e-mail address: charles.prince@isp.uk. The given name “charles” can be compared with a name database to determine the gender of Charles to be male. The domain name “.uk” can be compared with a domain name database to determine that Charles is British. The surname “Prince” (or the given name Charles) can be used to determine that secondary metadata (e.g., address book entry) is available for Charles Prince. In this example, there is an electronic contact card for Charles, which provides a city (London) and date of birth (Apr. 25, 1964). The city information can be used to confirm that Charles lives in Britain. In some cases, the city information can determine a dialect for countries where dialect varies from region to region (e.g., USA, Canada). The date of birth can be used with the current date or the data of the communication to determine the age of the speaker.

Based on the primary and secondary metadata available, the speaker profile for Charles Prince is: Profile=[Male, Britain, London, 46]. The speaker profile is used by TTS engine 210 to select voice data that best matches the speaker profile. For example, an older male voice with a British accent. When the e-mail message 108 is converted to speech, the speech will be spoken by an older man with a British accent. Generally, the speaker profile can include any amount or type of information that can be used to determine a voice characteristic.

Second sources of metadata can be obtained from a variety of techniques. For example, the photo of Charles could be used with image processing to determine gender or can be used to search a local file system or external network (e.g., the World Wide Web) for information on Charles. Such information can be mined for secondary metadata. For example, previous e-mails or text messages (if saved) can be mined for additional information. Information on the Internet can also be used to refine the speaker profile for Charles. As more information is obtained, the speaker profile can be further refined.

In some implementations, the user can manually create or refine a speaker profile. For example, a speaker profile editor can be invoked on the playback device that allows the user to manually create or refine a stored speaker profile, and listen to the results immediately through an audio playback system. In some implementations, the speaker profile can be included as additional information for a contact in an electronic address book stored locally or on a network.

### Exemplary Voice Database

FIG. 3B illustrates voice database 208. Voice database 208 can be organized and indexed based on information in a speaker profile. In the example shown, a table in database 208 can include five columns: gender, country, city, age and voice. Referring to row 1 of the table, a speaker profile can have attribute-value pairs such as <gender:male>, <country:UK>, <city: London>, <age: 46>. The voice column can include a unique identifier associated with a set of voice parameters or recorded speech that can be used by TTS engine 210 to generate speech output based on the speaker profile. For the speaker profile in row 1, voice parameter set #1 is selected. This voice parameter set can be used by TTS engine 210 to produce speech output with the voice of an older British male. For the speaker profile in row 4, voice parameter set #4 is selected. This voice parameters set can be used by TTS engine 210 to produce speech output of a young female with a southern accent (southern USA). The availability of the city information (“Mobile”) is used to determine the dialect of the speech output. Other parameters can be included in the table to aid in dialect determination, such as state (“Alabama”) or region (“South East”).

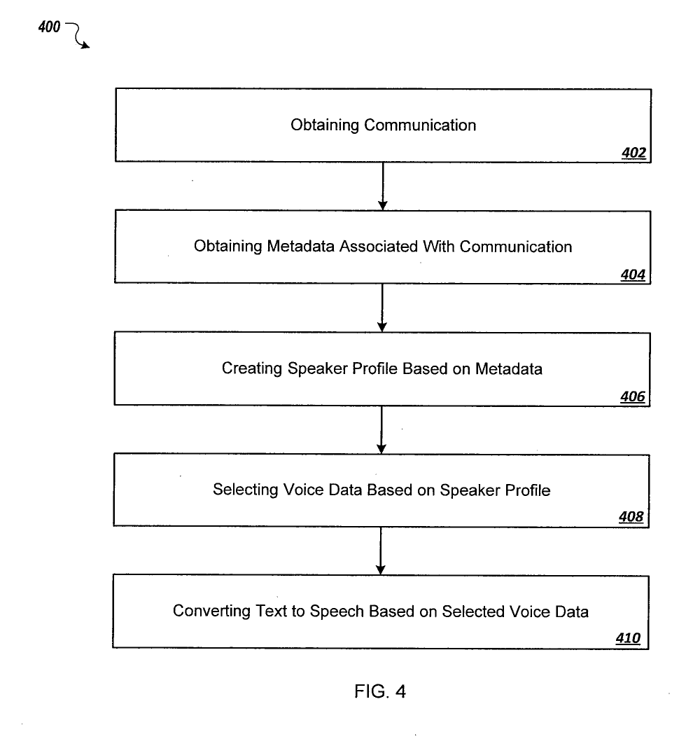

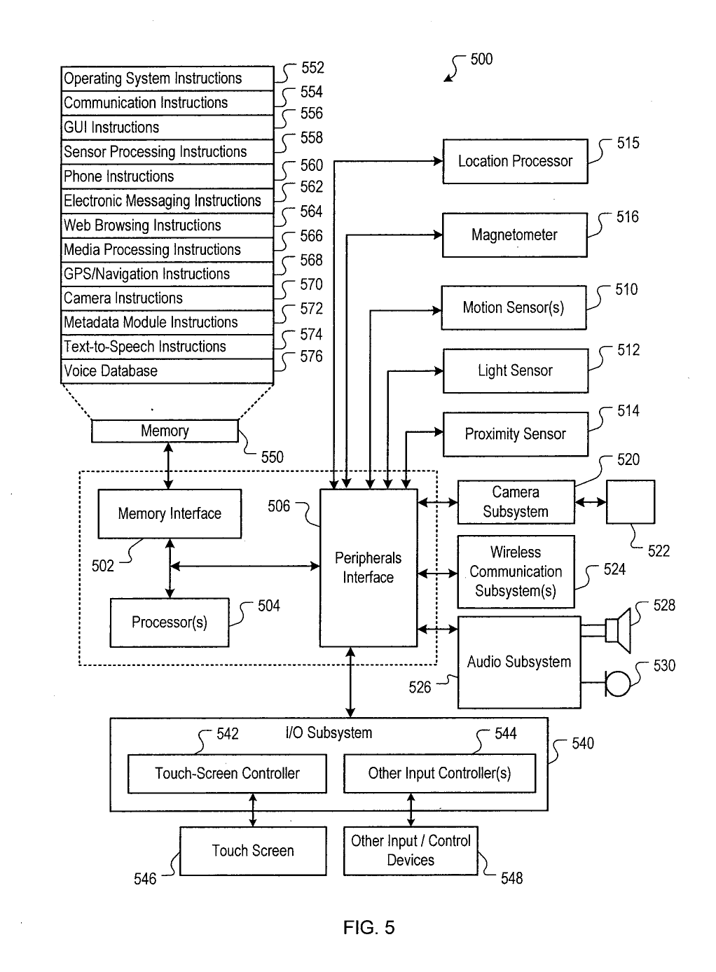

FIG. 4 is a flow diagram of an exemplary process 400 for voice assignment to speech output based on speaker profiles. Process 400 can be implemented by system 200 and device architecture 400, described in reference to FIGS. 2 and 5, respectively.

In some implementations, process 400 can begin by obtaining a communication (402). The communication can be e-mail, a text message or any other electronic communication that includes text that can be converted to speech (e.g., blog, webpage, user interface, tweet).

Process 400 can continue by obtaining metadata associated with the communication (404). The metadata can be primary or secondary metadata, as described in reference to FIGS. 1A and 1B. For example, if the communication is e-mail then the primary metadata can be the e-mail address of the speaker and secondary metadata can be contact information in an address book.

Process 400 can continue by creating a speaker profile based on the metadata (406). In some implementations, a speaker profile can be comprised of information that can be used to determine voice characteristics. The creating of a speaker profile can including parsing words from primary and secondary metadata, as described in reference to FIG. 3A.

Process 400 can continue by selecting voice data based on the speaker profile (408). For example, the speaker profile can be formed into a query for retrieving voice data from a voice database that is organized or indexed to respond to speaker profile queries. In some implementation, voice database can be a relational data that relates voice data with attribute-value pairs derived from speaker profile information, as described in reference to FIG. 3B.

Process 400 can continue by converting raw text into speech using the selected voice data (410), and outputting the speech on a device through a loudspeaker or headphone jack.

### Exemplary Device Architecture

FIG. 5 is a block diagram illustrating exemplary device architecture implementing features and operations described in reference to FIGS. 1-4. Device 500 can be any device capable of capturing handwriting on a touch sensitive surface, including but not limited to smart phones and electronic tablets. Device 500 can include memory interface 502, one or more data processors, image processors or central processing units 504, and peripherals interface 506. Memory interface 502, processor(s) 504 or peripherals interface 506 can be separate components or can be integrated in one or more integrated circuits. The various components can be coupled by one or more communication buses or signal lines.

Sensors, devices, and subsystems can be coupled to peripherals interface 506 to facilitate multiple functionalities. For example, motion sensor 510, light sensor 512, and proximity sensor 514 can be coupled to peripherals interface 506 to facilitate orientation, lighting, and proximity functions of the mobile device. For example, in some implementations, light sensor 512 can be utilized to facilitate adjusting the brightness of touch screen 546. In some implementations, motion sensor 510 (e.g., an accelerometer, gyros) can be utilized to detect movement and orientation of the device 500. Accordingly, display objects or media can be presented according to a detected orientation, e.g., portrait or landscape.

Other sensors can also be connected to peripherals interface 506, such as a temperature sensor, a biometric sensor, or other sensing device, to facilitate related functionalities.

Location processor 515 (e.g., GPS receiver) can be connected to peripherals interface 506 to provide geo-positioning. Electronic magnetometer 516 (e.g., an integrated circuit chip) can also be connected to peripherals interface 506 to provide data that can be used to determine the direction of magnetic North. Thus, electronic magnetometer 516 can be used as an electronic compass.

Camera subsystem 520 and an optical sensor 522, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 524. Communication subsystem(s) 524 can include one or more wireless communication subsystems. Wireless communication subsystems 524 can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The specific design and implementation of the communication subsystem 524 can depend on the communication network(s) or medium(s) over which device 500 is intended to operate. For example, a mobile device can include communication subsystems 524 designed to operate over a GSM network, a GPRS network, an EDGE network, a WiFi or WiMax network, and a Bluetooth network. In particular, the wireless communication subsystems 524 can include For example, device 500 may include wireless communication subsystems designed to operate over a global system for mobile communications (GSM) network, a GPRS network, an enhanced data GSM environment (EDGE) network, 802.x communication networks (e.g., WiFi, WiMax, or 3G networks), code division multiple access (CDMA) networks, and a Bluetooth™ network. Communication subsystems 524 may include hosting protocols such that the mobile device 500 may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 526 can be coupled to a speaker 528 and one or more microphones 530 to facilitate voice-enabled functions, such as voice recognition, voice replication, digital recording, and telephony functions.

I/O subsystem 540 can include touch screen controller 542 and/or other input controller(s) 544. Touch-screen controller 542 can be coupled to a touch screen 546 or pad. Touch screen 546 and touch screen controller 542 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch screen 546.

Other input controller(s) 544 can be coupled to other input/control devices 548, such as one or more buttons, rocker switches, thumb-wheel, infrared port, USB port, and/or a pointer device such as a stylus. The one or more buttons (not shown) can include an up/down button for volume control of speaker 528 and/or microphone 530.

In one implementation, a pressing of the button for a first duration may disengage a lock of the touch screen 546; and a pressing of the button for a second duration that is longer than the first duration may turn power to mobile device 500 on or off. The user may be able to customize a functionality of one or more of the buttons. The touch screen 546 can also be used to implement virtual or soft buttons and/or a keyboard.

In some implementations, device 500 can present recorded audio and/or video files, such as MP3, AAC, and MPEG files. In some implementations, device 500 can include the functionality of an MP3 player and may include a pin connector for tethering to other devices. Other input/output and control devices can be used.

Memory interface 502 can be coupled to memory 550. Memory 550 can include high-speed random access memory or non-volatile memory, such as one or more magnetic disk storage devices, one or more optical storage devices, or flash memory (e.g., NAND, NOR). Memory 550 can store operating system 552, such as Darwin, RTXC, LINUX, UNIX, OS X, WINDOWS, or an embedded operating system such as VxWorks. Operating system 552 may include instructions for handling basic system services and for performing hardware dependent tasks. In some implementations, operating system 552 can include a kernel (e.g., UNIX kernel).

Memory 550 may also store communication instructions 554 to facilitate communicating with one or more additional devices, one or more computers or one or more servers. Communication instructions 554 can also be used to select an operational mode or communication medium for use by the device, based on a geographic location (obtained by the GPS/Navigation instructions 568) of the device. Memory 550 may include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GPS/Navigation instructions 568 to facilitate GPS and navigation-related processes and instructions; camera instructions 570 to facilitate camera-related processes and functions; metadata module instructions 572 for the processes and features described with reference to FIGS. 1-4; text-to-speech instructions 574 for implementing the TTS engine 210 and voice database 576. The memory 550 may also store other software instructions for facilitating other processes, features and applications.

Each of the above identified instructions and applications can correspond to a set of instructions for performing one or more functions described above. These instructions need not be implemented as separate software programs, procedures, or modules. Memory 550 can include additional instructions or fewer instructions. Furthermore, various functions of the mobile device may be implemented in hardware and/or in software, including in one or more signal processing and/or application specific integrated circuits.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to, communicate with, one or more mass storage devices for storing data files; such devices include magnetic disks, such as internal hard disks and removable disks; magneto-optical disks; and optical disks.

Storage devices suitable for tangibly embodying computer program instructions and data include all forms of non-volatile memory, including by way of semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a player, the features can be implemented on a computer having a display device, such as a CRT (cathode ray tube) or LCD (liquid crystal display) monitor for displaying information to the player. The computer can also have a keyboard and a pointing device such as a game controller, mouse or a trackball by which the player can provide input to the computer.

The features can be implemented in a computer system that includes a back-end component, such as a data server, that includes a middleware component, such as an application server or an Internet server, or that includes a front-end component, such as a client computer having a graphical user interface or an Internet browser, or any combination of them. The components of the system can be connected by any form or medium of digital data communication such as a communication network. Some examples of communication networks include LAN, WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method performed by a device, the method comprising:
obtaining a communication including text;
obtaining metadata based on the communication;
creating a speaker profile based on the metadata;
selecting voice data based on the speaker profile; and
converting the text to speech based on the selected voice data, where the method is performed by one or more hardware processors of the device.

2. The method of claim 1, where the communication is e-mail.

3. The method of claim 1, where obtaining metadata based on the communication, further comprises:
obtaining metadata directly from the communication;
determining that additional metadata is available from the obtained metadata; and
obtaining the additional metadata.

4. The method of claim 2, where obtaining metadata based on the communication, further comprises:
determining gender and dialect based on at least a portion of the e-mail address.

5. The method of claim 4, further comprising:
determining that additional metadata is available based on at least a portion of the e-mail address; and
obtaining the additional metadata from an address book.

6. The method of claim 5, where the address book is located on a network external to the device.

7. The method of claim 1, creating a speaker profile based on the metadata, further comprises:
determining at least one of gender, dialect and age from the metadata.

8. The method of claim 1, where selecting voice data based on the speaker profile, further comprises:
comparing the speaker profile with attribute-value pairs in a database table; and
selecting voice data associated with an attribute-value pair that best matches the speaker profile.

9. The method of claim 8, where the voice data includes recorded speech having voice characteristics that best matches the speaker profile.

10. The method of claim 9, where the recorded speech is organized or indexed in a database based on information contained in the speaker profile.

11. The method of claim 10,
forming the speaker profile into a query of search terms; and
searching a database for recorded speech that best matches the query.

12. The method of claim 11, converting the text to speech based on the selected voice data, further comprises:
concatenating the recorded speech resulting from the search.

13. The method of claim 1, converting the text to speech based on the selected voice data, further comprises:
creating synthetic speech using the selected voice data, the selected voice data modeling a human vocal tract or other human voice characteristics.

14. A system comprising:
one or more processors;
memory storing instructions, which, when executed by the one or more processors, causes the one or more processors to perform operations comprising:
obtaining a communication including text;
obtaining metadata based on the communication;
creating a speaker profile based on the metadata;
selecting voice data based on the speaker profile; and
converting the text to speech based on the selected voice data.

15. The system of claim 14, where the communication is e-mail.

16. The system of claim 14, where the instructions cause the one or more processors to perform operations comprising:
obtaining metadata directly from the communication;
determining that additional metadata is available from the obtained metadata; and
obtaining the additional metadata.

17. The system of claim 15, where the instructions cause the one or more processors to perform operations comprising:
determining gender and dialect based on at least a portion of the e-mail address.

18. The system of claim 17, where the instructions cause the one or more processors to perform operations comprising:
determining that additional metadata is available based on at least a portion of the e-mail address; and
obtaining the additional metadata from an address book.

19. The system of claim 18, where the address book is located on a network external to the device.

20. The system of claim 14, where the instructions cause the one or more processors to perform operations comprising:
determining at least one of gender, dialect and age from the metadata.

21. The system of claim 14, where the instructions cause the one or more processors to perform operations comprising:
comparing the speaker profile with attribute-value pairs in a database table; and
selecting voice data associated with an attribute-value pair that best matches the speaker profile.

22. The system of claim 21, where the voice data includes recorded speech having voice characteristics that best matches the speaker profile.

23. The system of claim 22, where the recorded speech is organized or indexed in a database based on information contained in the speaker profile.

24. The system of claim 23, where the instructions cause the one or more processors to perform operations comprising:
forming the speaker profile into a query of search terms; and
searching a database for recorded speech that best matches the query.

25. The system of claim 24, where the instructions cause the one or more processors to perform operations comprising:
concatenating the recorded speech resulting from the search.

26. The system of claim 14, where the instructions cause the one or more processors to perform operations comprising:
creating synthetic speech using the selected voice data, the selected voice data modeling a human vocal tract or other human voice characteristics.
